(19) United States
(12) Patent Application Publication
(10) Pub. No.: US 2024/0262970 A1
(43) Pub. Date: Aug. 8, 2024

(54) METHOD FOR IMPROVING THE ADHESION OF SILICONE ELASTOMERS TO PRE-CURED SILICONE ELASTOMERIC SUBSTRATES, AND PRIMER COMPOSITION FOR SILICONE RUBBER COMPOSITIONS AND ELASTOMERIC MATERIALS

(71) Applicant: DOW SILICONES CORPORATION, Midland, MI (US)

(72) Inventors: Roman VANECEK, Wiesbaden (DE); Patrick BEYER, Wiesbaden (DE)

(21) Appl. No.: 18/636,223

(22) Filed: Apr. 15, 2024

Related U.S. Application Data
(63) Continuation-in-part of application No. 17/605,598, filed on Oct. 22, 2021.
(60) Provisional application No. 62/839,838, filed on Apr. 29, 2019.

(51) Int. Cl. C08J 7/043; C07F 7/08; C08F 130/08; C08K 3/36; C09D 5/00; C09D 143/04; C09J 5/00

(52) U.S. Cl. CPC C08J 7/043; C07F 7/087; C08F 130/08; C08K 3/36; C09D 5/002; C09D 143/04; C09J 5/00; C08J 2383/04; C08K 2201/019; C09J 2483/003

(57) ABSTRACT

There is described a primer composition comprising a silicone polyether, a reinforcing filler, one or more polydiorganosiloxane polymer(s) and a carrier and the preparation and use thereof. The primer composition is particularly designed for use with silicone elastomers especially for addition (hydrosilylation) curing silicone elastomers, the preparation thereof, and to a process for improving the adhesion of silicone elastomeric compositions to pre-cured silicone elastomer material substrates. A method for improving the adhesion of silicone elastomer to a pre-cured silicone elastomeric substrate is provided. The method comprises: applying a primer composition to a silicone elastomer substrate; optionally, air-drying (or baking) the primer composition to form a uniform primer film covering the substrate; applying a hydrosilylation curable silicone rubber composition to the substrate covered with the primer to obtain a composite; and curing the composite in order to obtain a silicone elastomer adhesively bonded to a silicone elastomer substrate.

### CROSS-REFERENCE TO RELATED APPLICATIONS

This application is a continuation-in-part of application Ser. No. 17/605,598 filed on 22 Oct. 2021, which is the U.S. National Stage of International Application No. PCT/US2020/030179 filed on 28 Apr. 2020, which claims priority to U.S. Application No. 62/839,838 filed on 29 Apr. 2019, the contents of which is incorporated herein by reference.

### TECHNICAL FIELD

This disclosure relates to a method for improving the adhesion of silicone elastomers to pre-cured silicone elastomeric substrates and to composites or composite articles formed from such a method. This disclosure also identifies a primer composition and the preparation and use thereof. The primer composition (or “primer”) is particularly designed for use with silicone elastomers (often referred to as “silicone rubbers”) especially for addition (hydrosilylation) curing silicone elastomers, the preparation thereof, and to a process for improving the adhesion of silicone elastomeric compositions to pre-cured silicone elastomer material substrates.

### BACKGROUND OF THE INVENTION

Silicone elastomers have properties which make them preferable to other elastomers in many applications, an example being their thermal stability over a wide temperature range. In some applications where silicone elastomer/silicone elastomer overmolding is desired, e.g., subsea insulation, high-voltage electrical insulation, 3-D printing, lens and consumer applications, strong bonds need to be developed between pre-formed silicone elastomeric materials and uncured silicone elastomeric compositions as they cure. If an adequate bond to the silicone elastomer substrate cannot be achieved directly the bond strength can be improved by pretreatment of the substrate surface with a suitable primer.

For example, silicone elastomeric insulation material is used to insulate subsea oil and gas production equipment. In many subsea locations, e.g., where subsea oil and gas wells are located at depths of 1,500 m or greater, the pipelines and wellhead equipment are exposed to seawater which is just a few degrees above freezing (e.g., about 4° C. to 5° C.). In the absence of insulation, hot produced hydrocarbon fluids within the production equipment are cooled by the surrounding seawater which, if the temperature of the fluids approaches the seawater temperature, can result in hydrates and paraffin waxes being formed within the pipeline, consequentially causing a restriction of hydrocarbon flow or even blockages within the pipelines. To perform successfully in this environment, a thermal insulation material must have a low thermal conductivity, exhibit acceptable mechanical properties such as flexibility and impact resistance, and be economical to install and preferably should be resistant to high temperature aqueous environments.

Liquid silicone rubber (“LSR”) based materials made using organopolysiloxane polymers having viscosities of up to about 500,000 mPa·s at 25° C. have been utilized for subsea insulation but while having advantages over the above because of the ability to withstand wide temperature variations without an appreciable effect on their physical properties and being virtually unaffected by ultraviolet (“UV”) radiation, even over long periods of time, ozone, oil, salt, water and the like, can degrade such materials.

Furthermore, because of the relatively low viscosity of the pre-cured LSR compositions, it is difficult to apply the compositions around subsea equipment, such as the pipes, wellheads and Christmas (or “Xmas”) trees, LSR insulation material is applied onto items of subsea equipment for insulation purposes using a sequential molding (i.e., cast-in-place) process. In such a process, a mold/form is placed in position for a first section of insulation around the item, LSR is subsequently pumped in and cured to a predetermined hardness and the mold/form is then removed. The process is then repeated for a second section and consequently for as many sections as required to complete the total insulation of the item of subsea equipment. However, such a sequential process results in multiple joint sections having neighboring LSR/LSR (silicone elastomeric/silicone elastomeric) interfaces.

It is generally anticipated that such interfaces will adhere together in both subsea and all the other applications referred to above because the LSRs utilized for such insulation applications are provided with an excess of silicon bonded hydrogen groups (i.e., Si—H groups) so that post cure a sufficient proportion of unreacted Si—H groups are available at the cured interface of a first section in order to interact with unsaturated groups in the interface of a subsequently curing second section resulting in the two sections to completely cure the interfaces to a desired crosslink density. The same scenario being repeated between a cured interface of the second section with an uncured third section and for each subsequent section cured in place sequentially until the subsea item has been fully insulated with the neighboring sections adhered to each other sufficiently strongly for cohesive failure evident along the entire matrix.

However, while the silicone rubber insulation provides excellent insulative properties it has been identified that the adhesion/bonding between adjacent interfaces of neighboring sections is often inadequate for this purpose, particularly given the extreme temperatures and environmental conditions endured.

A wide variety of primers have previously been proposed for adhering liquid silicone rubbers to substrates. The efficiency of the primer is dependent both on the chemical nature and surface characteristics of the substrate, and composition which is to be adhered to the substrate, e.g., the nature of the adjacent interfaces of neighboring section of insulation, the crosslinking system and the viscosity of the silicone rubber which is to be adhered. While a wide variety of primers have been proposed, a large proportion are combinations of two or more of organofunctional alkoxysilanes such as tetraalkoxysilanes, epoxytrialkoxysilane, vinyltrialkoxysilane and/or methacryloxypropyltrimethoxysilane or partial hydrolysis products of such organofunctional alkoxysilanes, SiH functional intermediates, metal alkoxides and/or metal chelates, e.g., titanates, often together with a suitable solvent. These may be provided as one-part or multi-part compositions mixed together immediately prior to use.

Examples include:
a titanium alkoxide and an alkyl polysilicate or partial hydrolysis product thereof;
tetraalkyl titanate, at least one alkyl orthosilicate and a hydrocarbon solvent;
a tetraalkyl titanate, an organyloxysilane, for example tetraethyl orthosilicate, and an organic solvent;
a silane which contains no amino or amido functionality such as methacryloyloxypropyltrimethoxysilane, a metal ester, preferably an inorganic acid, and an organic solvent; and
a tetraalkoxysilane and/or partial hydrolysis product thereof; a metal salt, alkoxide, or chelate and/or a partial hydrolysis product thereof; a silicone resin; and a solvent.

Int. Pub. No. WO 2018/234783 A1 describes a subsea insulation system utilizing two distinct primers. In this system, there is a dual layer of silicone elastomer insulation around substrates, e.g., metal pipes. A first primer is used to adhere the silicone elastomer to the metal substrate while the second primer is used to adhere the overmolding of a second layer of silicone rubber onto a base layer of silicone rubber. The description advises that the primers may be the same but, in the examples, they are different and the primer for the silicone elastomer/silicone elastomer interface consists of:
a linear polydialkylsiloxane having from 3 to 15 silicon atoms, or optionally 3 to 10 silicon atoms;
RₙSi—(OR⁹)₄₋ₙ where n may be 0, 1 or 2, preferably n is 0 or 1, and R may be a non-hydrolysable silicon-bonded organic group such as hydrocarbyl groups, and each R⁹ is the same or different and is an alkoxy group having from 1 to 6 carbon atoms;
a titanate of the general formula Ti[OR²]₄ where each R₂ may be the same or different and represents a monovalent, primary, secondary or tertiary aliphatic hydrocarbon group which may be linear or branched containing from 1 to 10 carbon atoms; and

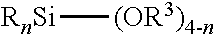

where n may be 0, 1 or 2, preferably n is 0 or 1, where R is as described above, and each R³ is the same or different and is an alkoxy group having from 1 to 6 carbon atoms or an alkoxyalkylene group in which the alkoxy group has from 1 to 6 carbon atoms and the alkylene chain has from 1 to 6 carbon atoms.

There is still a need in the industry for a primer that is easy to apply in an industrial environment, and that provides for strong silicone elastomer to silicone elastomer layer adhesion. There is also a need for methods of improving adhesion to various substrates, and for methods of forming and using primers for adhering materials together.

### SUMMARY OF THE INVENTION

Provided is a method for improving the adhesion of silicone elastomer to a pre-cured silicone elastomeric substrate. The method comprises applying a primer composition to a silicone elastomer substrate. Optionally, the method further comprises air-drying or baking the primer composition to form a uniform primer film covering the substrate. The method further comprises applying a hydrosilylation curable silicone rubber composition to the substrate covered with the primer to obtain a composite. The method further comprises curing the composite to obtain a silicone elastomer adhesively bonded to a silicone elastomer substrate.

The primer composition comprises: (A) a silicone polyether; (B) a reinforcing filler; (C) one or more polydiorganosiloxane polymer(s); and (D) a carrier. The one or more polydiorganosiloxane polymer(s) of component (C) have a viscosity of from 1,000 to 500,000 mPa·s at 25° C. and contain at least one alkenyl group or alkynyl group per molecule.

Thus, in accordance with the present disclosure there also is provided the primer composition (or “primer” or “composition”). The primer comprises components (A), (B), (C), and (D), as described above. Optionally, the primer may comprise one or more additional components as described further below.

It will be appreciated that conventional primers typically contain ingredients which undergo chemical reactions to enhance the adhesive properties such as alkoxysilanes, which hydrolyze with moisture subsequent to application in a primer and then undergo condensation reaction in order to enhance adhesion with such primers. Therefore, the conventional primers also regularly contain condensation catalysts, usually titanium- and/or zirconium-based condensation catalysts, to accelerate this hydrolysis/condensation reaction. It will be noted and appreciated therefore that the inventive primer described herein is of a completely different formulation which substantially won't react (or won't react at all) when exposed to humidity, moisture, water, etc. Specifically, the inventive primer generally does not (or does not) contain the aforementioned adhesion enhancing or promoting ingredients described above.

### DETAILED DESCRIPTION OF THE EMBODIMENTS

Component (A) of the primer described herein is a silicone polyether, i.e., a copolymer comprising a combination of siloxane and polyether (i.e., polyoxyalkylene) blocks.

Each silicone portion of the silicone polyether is a polydiorganosiloxane chain having multiple units of the general formula (I):

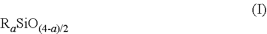

In formula (I), each R is independently selected from an aliphatic hydrocarbyl, aromatic hydrocarbyl, or organyl group (that is, any organic substituent group, regardless of functional type, having one free valence at a carbon atom). Saturated aliphatic hydrocarbyls are exemplified by, but not limited to, alkyl groups such as methyl, ethyl, propyl, pentyl, octyl, undecyl, and octadecyl, and cycloalkyl groups such as cyclohexyl. Unsaturated aliphatic hydrocarbyls are exemplified by, but not limited to, alkenyl groups such as vinyl, allyl, butenyl, pentenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups such as chloromethyl and 3-chloropropyl; nitrogen containing groups such as amino groups, amido groups, imino groups, and imido groups; oxygen containing groups such as polyoxyalkylene groups, carbonyl groups, alkoxy groups and hydroxyl groups. Further organyl groups may include sulfur containing groups, phosphorus containing groups and/or boron containing groups. In the case of the present polyether, each R is generally independently selected from an aliphatic hydrocarbyl, or from an aromatic hydrocarbyl. The subscript “a” may be 0, 1, 2 or 3, but is typically 2 or 3.

The foregoing siloxy units in formula (I) above may be described in a shorthand (abbreviated) nomenclature, namely—“M,” “D,” “T,” and “Q,” when R is an organic group, typically methyl group (further teaching on silicone nomenclature may be found in Walter Noll, Chemistry and Technology of Silicones, dated 1962, Chapter I, pages 1-9). The M unit corresponds to a siloxy unit where a=3, that is R₃SiO_{1/2}; the D unit corresponds to a siloxy unit where a=2, namely R₂SiO_{2/2}; the T unit corresponds to a siloxy unit where a=1, namely R₁SiO_{3/2}; and the Q unit corresponds to a siloxy unit where a=0, namely SiO_{4/2}. Hence when a in formula (I) above is 2 the siloxy unit is a D unit and when a in formula (I) above is 3 the siloxy unit is a T unit. Generally, in silicone polyethers the silicone blocks comprise chains of D units with branching via T units possible. Examples of typical R groups on the polydiorganosiloxane polymer include alkenyl, alkyl, and/or aryl groups, optionally alkyl groups having 1 to 6 carbons, or optionally methyl groups. The groups may be in pendent position (i.e., on a D or T siloxy unit) or may be terminal (i.e., on an M siloxy unit).

The polyether portion of such copolymers comprises recurring oxyalkylene units, illustrated by the average formula (—CₙH₂ₙ—O—)_{y} wherein n is an integer from 2 to 4 inclusive and y is an integer ≥4, i.e., of at least four. Moreover, the oxyalkylene units are not necessarily identical throughout the polyoxyalkylene but can differ from unit to unit. A polyoxyalkylene, for example, can comprise oxyethylene units (—C₂H₄—O—), oxypropylene units (—C₃H₆—O—) or oxybutylene units (—C₄H₈—O—), or mixtures thereof. Preferably, the polyoxyalkylene polymeric backbone consists essentially of oxyethylene units or oxypropylene units. Other polyoxyalkylenes may include, for example: units of the structure:

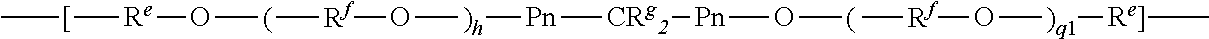

in which Pn is a 1,4-phenylene group, each R^{e} is the same or different and is a divalent hydrocarbon group having 2 to 8 carbon atoms, each R^{f} is the same or different and is an ethylene group or a propylene group, each R^{g} is the same or different and is a hydrogen atom or methyl group and each of the subscripts h and q1 is a positive integer in the range of from 3 to 30.

One preferred type of polyether chain within the silicone polyether is a polyoxyalkylene polymer chain comprising recurring oxyalkylene units of the formula (—CₙH₂ₙ—O—) wherein n is an integer from 2 to 4 inclusive.

Generally, the end of each polyoxyalkylene block Z¹ is linked to a siloxane block by a divalent organic group. This linkage is determined by the reaction employed to prepare the block silicone polyether copolymer. The divalent organic groups at the ends of Z may be independently selected from divalent hydrocarbons containing 2 to 30 carbons and divalent organofunctional hydrocarbons containing 2 to 30 carbons. Representative, non-limiting examples of such divalent hydrocarbon groups include ethylene, propylene, butylene, pentylene, hexylene, heptylene, octylene, and the like. Representative, non-limiting examples of such divalent organofunctional hydrocarbons groups include acrylate and methacrylate. In certain embodiments, the divalent hydrocarbon groups include ethylene, propylene, butylene, pentylene, hexylene, heptylene or octylene, or optionally ethylene, propylene, or butylene.

The silicone polyether may be of any type, for example the silicone polyether may be (AB)ₙ type silicone polyether wherein blocks of a siloxane unit and polyoxyalkylene organic units repeat to form the copolymer but in the present case have M terminal groups and as such may be depicted as

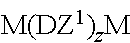

wherein M and D are as defined above and each Z¹ is a polyoxyalkylene polymer chain block and z is an integer ≥2 and M is an Me₂OHSiO_{1/2} terminal group. Optionally, the silicone polyether may be an ABA type silicone polyether of the type MDZ¹DM wherein Mis Me₂OHSiO_{1/2} or a hydroxy terminated Z¹DZ¹ silicone polyether such as, for the sake of example

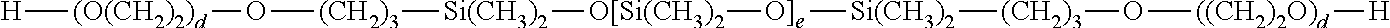

where d and e are integers.

Optionally, the copolymer may take the form of a “rake” copolymer where a predominately linear polyorganosiloxane provides the “backbone” of the copolymer architecture with pendant organic blocks forming the rake which may depicted as

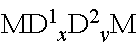

wherein M is as defined above and D¹ represents a unit of the formula (R³)₂SiO_{2/2} and D² represents a unit of the formula (R³)(Z²)SiO_{2/2} wherein Z² represents is a monovalent polyether block and R³ is as described above.

In certain embodiments when the copolymers are ABA or (AB)ₙ type copolymers as described above, n is 1, 2 or 3 and for rake copolymers n is zero, 1, 2 or 3, optionally zero or 1, or optionally zero.

The viscosity of the ABA or (AB)ₙ type block silicone polyether copolymers is preferably between from 1,000 mPa·s to 200,000 mPa·s at 25° C. using a Brookfield® rotational viscometer using Spindle (LV-4) and adapting the speed according to the polymer viscosity and all viscosity measurements were taken at 25° C. unless otherwise indicated. As understood in the art, an (AB)ₙ type block copolymer has alternating A and B units, and the molar ratio of each monomer in the copolymer is typically close to one (or is one). Meanwhile, an ABA type block copolymer is a triblock copolymer, and the molar ratio of A:B is typically close to two (or is two).

When the copolymer is a rake copolymer, it is preferred that the organic component Z² is a polyether-containing substituent comprising recurring oxyalkylene units of the formula (—CₙH₂ₙ—O—) wherein n is an integer from 2 to 4 inclusive. The polyether-containing substituent may be linked to a silicon atom in the polymer backbone chain via a divalent organic group as described above for Z¹ and has a terminal —OH or alkoxy group, wherein the alkoxy group has from 1 to 6 carbon atoms, optionally an —OH or a methoxy or an ethoxy group, or optionally an —OH group. Typically, the polyether side chains in such rake copolymers will contain from 2 to 150 alkylene oxide units per side chain.

The primer composition herein is described by way of solids content weight % (“wt. %”), i.e., the weight % of ingredients/components of the primer excluding carrier/component (D) i.e., components (A), (B), and (C) and optionally any additives when present and/or total content weight % (wt. %) for primer compositions wherein the amount of carrier/component (D) present is included. In each instance, the primer composition when all ingredients/components are added together makes 100 wt. %.

Silicone polyether/component (A) is present in an amount of from 0.05 wt. % to 10 wt. % of the solids content of the composition, optionally 0.05 wt. % to 7.5 wt. % of the solids content of the composition, or optionally 0.1 wt. % to 5.0 wt. % of the solids content of the composition. Hence, for example, the silicone polyether may be present in the total composition in an amount of from 0.05 wt. % to 4 wt. % of the total composition, optionally 0.05 wt. % to 2.5 wt. % of the total composition, or optionally 0.1 wt. % to 2.5 wt. % of the total composition.

Component (B) of the composition is a reinforcing filler such as finely divided fumed silica and/or a finely divided precipitated silica and/or suitable silicone resins. As understood in the art, “finely divided” is generally meant that the filler is not lumped together in lumps (or agglomerates) but is a collection of discrete particles/powder. In certain embodiments, the reinforcing filler is selected from the group consisting of fumed silica, precipitated silica, and combinations thereof. Such fillers can be of various particle size and distribution. Suitable silica fillers are understood in the art.

Finely divided forms of silica are preferred reinforcing fillers (B). Precipitated silica fumed silica and/or colloidal silicas are particularly preferred because of their relatively high surface area, which is typically at least 50 m²/g (BET method in accordance with ISO 9277: 2010). Fillers having surface areas of from 50 to 450 m²/g (BET method in accordance with ISO 9277: 2010), or optionally of from 50 to 300 m²/g (BET method in accordance with ISO 9277: 2010), are typically used. All these types of silica are commercially available.

When reinforcing filler (B) is naturally hydrophilic (e.g., untreated silica fillers), it is typically treated with a treating agent to render it hydrophobic. These surface modified reinforcing fillers (B) do not clump and can be homogeneously incorporated into polydiorganosiloxane polymer/component (C), described below, as the surface treatment makes the fillers easily wetted by polydiorganosiloxane polymer (C).

Typically, reinforcing filler (B) may be surface treated with any low molecular weight organosilicon compounds disclosed in the art applicable to prevent creping (or crepe hardening) of organosiloxane compositions during processing. For example, organosilanes, polydiorganosiloxanes, or organosilazanes e.g., hexaalkyl disilazane, short chain siloxane diols or fatty acids or fatty acid esters such as stearates can be used to render the reinforcing filler(s) hydrophobic and therefore easier to handle and obtain a homogeneous mixture with the other ingredients/components. Specific examples include, but are not limited to, silanol terminated trifluoropropylmethyl siloxane, silanol terminated vinyl methyl (ViMe) siloxane, tetramethyldi(trifluoropropyl)disilazane, tetramethyldivinyl disilazane, silanol terminated MePh siloxane, liquid hydroxyl-terminated polydiorganosiloxane containing an average from 2 to 20 repeating units of diorganosiloxane in each molecule, hexaorganodisiloxane, and hexaorganodisilazane. A small amount of water can be added together with the silica treating agent(s) as a processing aid. In other embodiments, water is not used.

The surface treatment may be undertaken prior to introduction in the composition or in situ (i.e., in the presence of at least a portion of the other ingredients/components of the composition herein by blending these ingredients/components together at room temperature or above until the filler is completely treated. Typically, untreated reinforcing filler (B) is treated in situ with a treating agent in the presence of polydiorganosiloxane polymer (C) which results in the preparation of a silicone rubber base material which can subsequently be mixed with other ingredients/components.

Reinforcing filler/component (B) is present in an amount of from 5.0 to 40 wt. % of the solids content of the composition, optionally of from 7.5 to 35 wt. % of the solids content of the composition, or optionally of from 10.0 to 35 wt. % based on the weight % of the solids content of the composition. Hence, the amount of reinforcing filler (B), e.g., finely divided silica and/or silicone resins in the primer composition herein may therefore be for example, from 2.0 to 20 wt. % of the total composition, or optionally of from 2.5 to 15 wt. % of the total composition. In some instances, the amount of reinforcing filler may be of from 5.0 to 15 wt. % based on the weight of the total composition.

Component (C) is one or more polydiorganosiloxane polymer(s). The one or more polydiorganosiloxane polymer(s) have a viscosity of from 1,000 to 500,000 mPa·s at 25° C. The polydiorganosiloxane polymer(s) also contain at least alkenyl and/or at least one alkynyl group per molecule, optionally at least two alkenyl and/or alkynyl groups per molecule, or optionally at least two alkenyl groups per molecule. Like the siloxane chains in silicone polyether (A), polydiorganosiloxane polymer (C) has multiple units of the general formula (I):

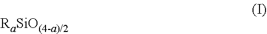

In formula (I), each R is independently selected from an aliphatic hydrocarbyl, aromatic hydrocarbyl, or organyl group (that is, any organic substituent group, regardless of functional type, having one free valence at a carbon atom). Saturated aliphatic hydrocarbyls are exemplified by, but not limited to, alkyl groups such as methyl, ethyl, propyl, pentyl, octyl, undecyl, and octadecyl, and cycloalkyl groups such as cyclohexyl. Unsaturated aliphatic hydrocarbyls are exemplified by, but not limited to, alkenyl groups such as vinyl, allyl, butenyl, pentenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups such as chloromethyl and 3-chloropropyl; nitrogen containing groups such as amino groups, amido groups, imino groups, and imido groups; oxygen containing groups such as polyoxyalkylene groups, carbonyl groups, alkoxy groups and hydroxyl groups. Further organyl groups may include sulfur containing groups, phosphorus containing groups and/or boron containing groups. The subscript “a” may be 0, 1, 2 or 3, but is typically 2 or 3.

Examples of typical groups on the polydiorganosiloxane polymer (C) include alkenyl, alkyl, and/or aryl groups. The groups may be in pendent position (i.e., on a D or T siloxy unit) or may be terminal (i.e., on an M siloxy unit). Hence, suitable alkenyl groups in polydiorganosiloxane polymer (C) typically contain from 2 to 10 carbon atoms, e.g., vinyl, isopropenyl, allyl, and 5-hexenyl.

The silicon-bonded organic groups attached to polydiorganosiloxane polymer (C) other than alkenyl groups are typically selected from monovalent saturated hydrocarbon groups, which typically contain from 1 to 10 carbon atoms, and monovalent aromatic hydrocarbon groups, which typically contain from 6 to 12 carbon atoms, which are unsubstituted or substituted with groups that do not interfere with curing of the inventive composition, such as halogen atoms. Preferred species of the silicon-bonded organic groups are, for example: alkyl groups such as methyl, ethyl, and propyl; and aryl groups such as phenyl.

The molecular structure of polydiorganosiloxane polymer (C) is typically linear, however, there can be some branching due to the presence of T units (as previously described) within the molecule.

The viscosity of polydiorganosiloxane polymer (C) should be at least 1,000 mPa·s at 25° C. The upper limit for the viscosity of polydiorganosiloxane polymer (C) is generally limited to a viscosity of up to 500,000 mPa·s at 25° C.

Generally, the (or each) polydiorganosiloxane containing at least two silicon-bonded alkenyl groups per molecule of component (C) has a viscosity of from 1,000 mPa·s to 150,000 mPa·s at 25° C., optionally from 1,000 mPa·s to 125,000 mPa·s, or optionally from 1,000 mPa·s to 50,000 mPa·s, at 25° C. In each case above the viscosity is measured in accordance with the cup/spindle method of ASTM D 1084 Method B, using the most appropriate spindle from the Brookfield® RV or LV range for the viscosity range.

The polydiorganosiloxane polymer (C) may be selected from polydimethylsiloxanes, alkylmethylpolysiloxanes, alkylarylpolysiloxanes or copolymers thereof containing, e.g., alkenyl and/or alkynyl groups and may have any suitable terminal groups, for example, they may be trialkyl terminated, alkenyldialkyl terminated or may be terminated with any other suitable terminal group combination providing each polymer contains at least two alkenyl groups per molecule. Optionally, the polydiorganosiloxane polymer (C) may be partially fluorinated, e.g., it may comprise trifluoroalkyl, e.g., trifluoropropyl groups and or perfluoroalkyl groups. Hence the polydiorganosiloxane polymer (C) may be, for the sake of example, dimethylvinyl terminated polydimethylsiloxane, dimethylvinylsiloxy-terminated dimethylmethylphenylsiloxane, trialkyl terminated dimethylmethylvinyl polysiloxane or dialkylvinyl terminated dimethylmethylvinyl polysiloxane copolymers.

For example, a polydiorganosiloxane polymer (C) containing alkenyl groups at the two terminals may be represented by the general formula (II):

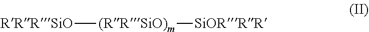

In formula (II), each R′ may be an alkenyl group or an alkynyl group, which typically contains from 2 to 10 carbon atoms. Alkenyl groups include, but are not limited to, vinyl, propenyl, butenyl, pentenyl, and hexenyl, an alkenylated cyclohexyl group, heptenyl, octenyl, nonenyl, decenyl or similar linear and branched alkenyl groups and alkenylated aromatic ringed structures. Alkynyl groups may be selected from, but are not limited to, ethynyl, propynyl, butynyl, pentynyl, and hexynyl, an alkynylated cyclohexyl group, heptynyl, octynyl, nonynyl, decynyl or similar linear and branched alkenyl groups and alkenylated aromatic ringed structures.

R″ does not contain ethylenic unsaturation, Each R″ may be the same or different and is individually selected from monovalent saturated hydrocarbon groups, which typically contain from 1 to 10 carbon atoms, and monovalent aromatic hydrocarbon groups, which typically contain from 6 to 12 carbon atoms. R″ may be unsubstituted or substituted with one or more groups that do not interfere with curing of the inventive composition, such as halogen atoms. R′″ is R′ or R″.

The one or more polydiorganosiloxane polymer(s) (C) having a viscosity of from 1,000 to 500,000 mPa·s at 25° C. containing at least one alkenyl group or alkynyl group per molecule is present in an amount of from 40 to 90 wt. % of the solids content of the composition, optionally from 45 to 85 wt. % of the solids content of the composition, or optionally from 50 to 85 wt. % of the solids content of the composition. Hence, polydiorganopolysiloxane polymer (C), is typically a dimethylvinyl terminated polydimethylsiloxane present in an amount of from 15 to 45 wt. % of the total composition, optionally from 15 to 40 wt. % of the total composition, or optionally from 15 to 35 wt. % of the total composition.

Component (D) of the composition is a suitable carrier, i.e., a diluent, suitable for reducing the viscosity of the composition containing, e.g., components (A), (B) and (C) (and optionally one or more additives) to allow application to a substrate in a low viscosity liquid form by a suitable method such as spraying, rolling, brushing, application with a knife coater or the like or the substrate may in certain circumstances be coated by immersion in a bath of primer. Any suitable carrier may be utilized for this purpose.

The carrier may optionally be volatile so that component (D) is able to at least partially evaporate after application of the composition. By “volatile,” it is generally meant that at least some of the carrier will evaporate, typically while at ambient temperature and pressure (e.g., 25° C. and 1 atm, or thereabouts). Of course, elevated temperature and/or reduced pressure can generally increase evaporation speed and/or evaporation amount of the carrier from the composition after application.

The carrier may include short chain siloxanes containing from 3 to 20 silicon atoms in the siloxane backbone, optionally from 3 to 10 silicon atoms in the siloxane backbone, or optionally from 3 to 6 silicon atoms in the siloxane backbone, and may be linear branched or cyclic, although linear short chain siloxanes are preferred. Any such siloxanes are preferably non-VOC (“volatile organic compounds”) which evaporate at room temperature or thereabouts.

The carrier may optionally be a suitable organic carrier which may, if deemed appropriate, be volatile to enable partial evaporation after application. Examples include toluene, xylene, and similar aromatic hydrocarbon system solvents; n-hexane, ligroin, kerosene, mineral spirits, and similar aliphatic hydrocarbon system solvents; cyclohexane, decahydronaphthalene, and similar cycloaliphatic hydrocarbon system solvents; methanol, ethanol, n-propyl alcohol, isopropyl alcohol, n-butyl alcohol, isobutyl alcohol, tert-butyl alcohol, amyl alcohol, hexyl alcohol, and similar alcohol system solvents; acetone, methyl ethyl ketone, methyl isobutyl ketone, cyclohexanone, and similar ketone system solvents; diethylether, dibutylether, tetrahydrofuran,-1,4-dioxane, and similar ether system solvents; diethyl carbonate, dipropyl carbonate, ethylene carbonate, propylene carbonate, and other carbonate system solvents; ethyl acetate, n-propyl acetate, isobutyl acetate, and other acetic esters; and malonic esters, succinic esters, glutaric esters, adipate esters, phthalate esters, and other ester system solvents.

In many embodiments, the carrier is unreactive. In further embodiments, the carrier is both unreactive and sufficiently small to evaporate (as described above). As for being “sufficiently small,” it is generally meant that the molecule and/or chain length of the carrier is small and/or that the molecular weight is low relative to carriers having larger molecular structures, longer chain lengths, excessive branching, etc. or the relative to carriers having higher molecular weights, such that those that do not evaporate under standard temperature and pressure.

By “unreactive,” it is generally meant that the carrier does not include any functional groups that would react with any of the other primary components (A), (B), and (C). Moreover, the carrier will also not reactive with any of the optional additives that may be present in the composition. Conversely, conventional reactive carriers may include one or more functional groups, such as alkenyl (e.g., vinyl) groups that would react with one or more of components (A), (B) and (C) and/or with one or more optional additives. Such reactive carriers would participate in cure or reaction processes therein, which is not desirable in many to all embodiments of the subject invention.

The solids content of the primer may be diluted by the carrier in any suitable amount for the application in which it is to be used. For example, there may be 20 to 150 parts by weight, or optionally from 70 to 150 parts by weight of carrier (D) per 100 parts by weight of the solids content of the composition (i.e., components (A)+(B)+(C)+one or more optional additive(s)). Hence, for example, the carrier may be present in the primer in a range of from 50 wt. % to 80 wt. % of the total composition, or optionally from 55 wt. % to 75 wt. % of the total composition.

As mentioned above, optionally, the primer may comprise one or more additional ingredients/components (or “additives”), for example one or more organohydrogenpolysiloxanes or a hydrosilylation catalyst (but not both together as this would promote cure to take place). In certain embodiments, the composition includes one or more organohydrogenpolysiloxanes and no hydrosilylation catalyst(s). In other embodiments, the composition includes a hydrosilylation catalyst and no organohydrogenpolysiloxane(s). In yet other embodiments, the composition does not include an organohydrogenpolysiloxane or a hydrosilylation catalyst.

The organohydrogen polysiloxane may also be referred to as an Si—H compound or Si—H polymer.

Examples of organohydrogenpolysiloxanes which might be included in the primer if desired include, for example; trimethylsiloxy-terminated methylhydrogenpolysiloxane, trimethylsiloxy-terminated polydimethylsiloxane-methylhydrogensiloxane, dimethylhydrogensiloxy-terminated dimethylsiloxane-methylhydrogensiloxane copolymers, dimethylsiloxane-methylhydrogensiloxane cyclic copolymers, copolymers and/or silicone resins consisting of (CH₃)₂HSiO_{1/2} units, (CH₃)₃SiO_{1/2} units and SiO_{4/2} units, copolymers and/or silicone resins consisting of (CH₃)₂HSiO_{1/2} units and SiO_{4/2} units, copolymers and/or silicone resins consisting of (CH₃)₂HSiO_{1/2} units, SiO_{4/2} units and (C₆H₅)₃SiO_{1/2} units, and alternatives in which methyl is replaced by phenyl groups or other alkyl groups.

Optionally, the organohydrogenpolysiloxane may be a filler, e.g., silica treated with one of the above examples or other example compounds described herein.

In various embodiments, the Si—H polymer is included in the composition and may be a polyorganohydrogensiloxane, which is exemplified by: dimethylhydrogensiloxy-terminated polydimethylsiloxane, dimethylhydrogensiloxy-terminated poly(dimethylsiloxane/methylhydrogensiloxane), dimethylhydrogensiloxy-terminated polymethylhydrogensiloxane, trimethylsiloxy-terminated poly(dimethylsiloxane/methylhydrogensiloxane), trimethylsiloxy-terminated polymethylhydrogensiloxane, a resin consisting essentially of H(CH₃)₂SiO_{1/2} units and SiO₄/2 units, and a combination thereof.

In various embodiments, the polyorganohydrogensiloxane has the general formula:

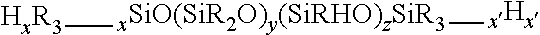

where each R is independently selected and as defined above, subscripts x and x′ are each independently 0 or 1, subscript y is from 0 to 250, and subscript z is from 0 to 250, with the provisos that y+z>1 and when z=0, x and x′ are both 1.

As will be appreciated from the formula above, the polyorganohydrogensiloxane comprises, optionally is, a linear polyorganohydrogensiloxane having an average of at least two silicon-bonded hydrogen atoms per molecule. As such, the polyorganohydrogensiloxane is useful as a cross-linker, and reacts with the ethylenically unsaturated groups of other compounds and/or components, e.g., when forming a coating (e.g., a primer coating) therewith.

With regard to the formula of the polyorganohydrogensiloxane above, subscripts y and z are independently from 0 to 100. In certain embodiments, subscripts y and z are independently from 0 to 100, optionally from 0 to 50, or optionally from 0 to 30. In specific embodiments, y+z=250, optionally 100, optionally 75, optionally 50, or optionally 30. In particular embodiments, one of subscript y and z is 0, and the other is an average value of from 1 to 100, optionally from 1 to 50, or optionally from 1 to 30. In specific embodiments, one of subscript y and z is 0, and the other is an average value of from 2 to 100, optionally from 2 to 50, optionally from 2 to 30, or optionally from 5 to 30.

In certain embodiments, the polyorganohydrogensiloxane includes pendent silicon-bonded hydrogen atoms. In such embodiments, the polyorganohydrogensiloxane may be a dimethyl, methyl-hydrogen polysiloxane having the average formula:

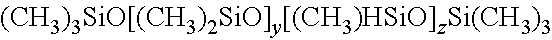

where subscripts y and z are defined above. One of skill in the art understands that in the exemplary formula above, the dimethylsiloxy units indicated by subscript y and methylhydrogensiloxy units indicated by subscript z may be present in randomized or block form, and that any methyl group may be replaced with any other hydrocarbon group free of aliphatic unsaturation (i.e., such that the methyl groups shown are to be understood as representative of other suitable groups defined above with respect to R).

In some embodiments, the polyorganohydrogensiloxane includes terminal silicon-bonded hydrogen atoms. In these embodiments, the polyorganohydrogensiloxane may be an SiH terminal dimethyl polysiloxane having the average formula:

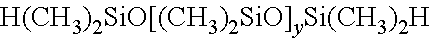

where subscript y is as defined above. The SiH terminal dimethyl polysiloxane may be utilized alone or in combination with the dimethyl, methyl-hydrogen polysiloxane described above. When the composition comprises such a mixture, the relative amount of each organohydrogensiloxane in the mixture may vary. One of skill in the art understands that any methyl group in the exemplary formula above may also be replaced with any other hydrocarbon group free of aliphatic unsaturation, as described above.

In specific embodiments, the polyorganohydrogensiloxane includes both pendent and terminal silicon-bonded hydrogen atoms. Such compounds are understood in the art, and can be, e.g., those having a formula as like above but where one or more methyl groups is replaced by hydrogen.

Particular examples of suitable polyorganohydrogensiloxanes include the following: dimethylhydrogensiloxy-terminated poly(dimethyl/methylhydrogen)siloxane copolymer; dimethylhydrogensiloxy-terminated polymethylhydrogensiloxane; trimethylsiloxy-terminated poly(dimethyl/methylhydrogen)siloxane copolymer; trimethylsiloxy-terminated polymethylhydrogensiloxane; and combinations thereof. Suitable polyorganohydrogensiloxanes are commercially available.

The hydrosilylation catalysts which may be used as an additive in the primer are any suitable hydrosilylation catalyst that can be used to cure hydrosilylation curable silicone compositions as discussed further below. In particular, one of the platinum metals (platinum, ruthenium, osmium, rhodium, iridium and palladium), or a compound of one or more of such metals. If a hydrosilylation catalyst is utilized, platinum and platinum compounds are preferred due to the high activity level of these catalysts in hydrosilylation reactions. Any of the hydrosilylation catalysts indicated below might be introduced into the primer if required or if desired. Otherwise, the composition may be free of a catalyst, e.g., free of a hydrosilylation catalyst, and/or free of a condensation catalyst, etc.

Hence, the primer may comprise:
(A) a silicone polyether in an amount of from 0.05 wt. % to 10 wt. %, optionally of from 0.05 wt. % to 7.5 wt. %, or optionally of from 0.1 wt. % to 5.0 wt. %, based on the weight % of the solids content of the composition;
(B) a reinforcing filler in an amount of from 5.0 to 40 wt. %, optionally of from 7.5 to 35 wt. %, or optionally of from 10.0 to 35 wt. %, based on the weight % of the solids content of the composition; and
(C) one or more polydiorganosiloxane polymer(s) having a viscosity of from 1,000 to 500,000 mPa·s at 25° C. and containing at least one alkenyl group or alkynyl group per molecule in an amount of from 40 to 90 wt. %, optionally of from 45 to 85 wt. %, or optionally of from 50 to 85 wt. %, based on the weight % of the solids content of the composition; wherein the solids content of the composition is the composition content excluding carrier (D), i.e., components (A), (B), and (C) and optionally any additives when present.
   Carrier/component (D) may be present in an amount of from 20 to 150 parts by weight, or optionally of from 70 to 150 parts by weight, per 100 parts by weight of the solids content of the composition. The solids content of the composition being any combination of the composition content excluding carrier/component (D), i.e., components (A), (B), and (C) and optionally any additives when present, but the total solids content of the composition by wt. % is 100 wt. %.

Hence, for the sake of example, when including when the carrier is included in the total composition, the total composition may be:
(A) a silicone polyether in an amount of from 0.05 wt. % to 4 wt. %, optionally of from 0.05 wt. % to 2.5 wt. %, or optionally of from 0.1 wt. % to 2.5 wt. %, based on the weight of the composition;
(B) a reinforcing filler in an amount of from 2.0 to 20 wt. %, optionally of from 2.5 to 15 wt. %, or optionally of from 5.0 to 15 wt. %, based on the weight of the composition; (C) one or more polydiorganosiloxane polymer(s) having a viscosity of from 1,000 to 500,000 mPa·s at 25° C. and containing at least one alkenyl group or alkynyl group per molecule in an amount of from 15 to 45 wt. %, optionally of from 15 to 40 wt. %, or optionally of from 15 to 35 wt. %, based on the weight of the composition; and
(D) a carrier in a range of from 50 wt. % to 80 wt. %, or optionally of from 55 wt. % to 75 wt. %, based on the weight of the composition.

The total composition may be any combination of the above alone or with additional additives with the total composition adding up to 100 wt. % including component (D) content.

As previously discussed, historically primers utilized to enhance the adhesion of silicone elastomers to substrates typically rely on “reactive chemistry processes,” e.g., the application of alkoxysilanes, which need to hydrolyze with moisture and then undergo a condensation reaction to be active with such a process being accelerated if required by use of a condensation catalyst, e.g., titanium- or zirconium-based compounds. The composition/primer of the present disclosure is considered non-reactive, as on its own no reaction occurs prior to application of the curable silicone elastomer composition as generally no catalyst or curing agent is present to induce crosslinking. Said another way, at least one of the catalyst and the curing agent is missing to prevent reaction, and in specific embodiments, both of the catalyst and the curing agent is missing to prevent reaction.

In various embodiments, the primer composition is free of a catalyst (or catalyst component). By “free of,” it is generally meant that the primer composition (and/or initial parts thereof) do/does not comprise a catalyst. In other words, out of 100 parts of the primer composition, e.g., including components (A), (B), (C), and (D), and optionally one or more additives, 0 parts of the 100 parts is catalyst. As understood in the art, catalysts are generally components that initiate and/or promote cure of one or more reactive components in a composition. In conventional silicone compositions, various cure systems can be used including one or more selected from addition (or hydrosilylation) cure, condensation cure, oxime cure, and peroxide cure. In certain embodiments, the composition includes one of the aforementioned catalysts, but is free of the others. For example, the composition may include a hydrosilylation catalyst, but exclude any other type, e.g., condensation cure, oxime cure, and peroxide cure catalysts. Other course, other combinations and exclusions are also possible in view of the foregoing.

With addition cure, the hydrosilylation catalyst is often platinum-based, e.g., is a platinum complex catalyst. Other conventional hydrosilylation catalysts are understood in the art, including those described elsewhere herein.

With condensation cure, organotitanate catalysts such as tetraalkoxy titanates or chelated titanates are often used in alkoxy-cured systems. Tin catalysts such as dibutyl tin dilaurate (“DBTDL”) can be used in oxime and acetoxy-cured systems. Other conventional condensation catalysts or oxime catalysts are understood in the art, including those described elsewhere herein.

With peroxide cure, various peroxides can be used, such as dicumyl peroxide, dichlorobenzoyl peroxide, etc. Other conventional peroxide catalysts are understood in the art, including those described elsewhere herein.

In certain embodiments, the primer composition consists essentially of components (A), (B), (C), and (D), and optionally one or more additives. In specific embodiments, the primer composition consists of components (A), (B), (C), and (D), and optionally one or more additives. In even more specific embodiments, the primer composition consists of components (A), (B), (C), and (D). In other more specific embodiments, the primer composition consists of components (A), (B), (C), (D) and an Si—H component. The Si—H component is as described above, with a specific example being the Si—H polymer described in the Examples section below.

While most prior art primers for silicone materials require a period of time, say at least 20 or 30 minutes, to air-dry in order for volatile carriers to evaporate and/or to vulcanize/condense; given the components of the primer described herein are typically unreactive with each other, a curable silicone rubber composition can be applied on to the primer herein almost immediately after primer application, although a short period of some drying time may be allowed if the carrier is volatile.

The preparation of the primer composition as hereinbefore described may be by any suitable method, for example by uniform mixing of components (A), (B), (C) and any optional components present in the composition in carrier (D) in a suitable mixing unit. The initial mixture may be either the complete composition or may be in the form of a concentrate or masterbatch which may be diluted by addition of further carrier (D).

The composition may be prepared as a one-part or multiple-part (i.e., two or more part) composition. The one-part composition may be prepared by combining all ingredients/components by any convenient means, such as mixing. All mixing steps or just a final mixing step may be performed under conditions that minimize or avoid heating (e.g., maintain temperature below 30° C. during mixing). The multiple-part (e.g., two-part) composition may be prepared where at least one component is stored in one part, and at least one other component is stored in a separate part, and the parts are combined (e.g., by mixing) shortly before use of the composition.

In many embodiments, the composition is a one-part composition. Optionally, the one-part composition can include a catalyst, e.g., a hydrosilylation catalyst. In other embodiments, the composition is a one-part composition that is free of catalyst. In other words, the composition is complete and ready for use, such that the composition is applied or otherwise used in the absence of a catalyst component. For example, the composition is applied to a substrate and then dried all while being free of a catalyst. That said, the substrate itself may include a catalyst therein or even thereon, but such catalyst is not part of the applied composition itself. In certain embodiments, the surface of the substrate to which the catalyst-free composition is applied is free of catalyst as well.

Hence, there is also provided a method for improving the adhesion of silicone rubber to a substrate by applying the primer composition according to the invention to the substrate. In certain embodiments, the primer composition is free of at least one of a catalyst and a curing agent, at least at the same time as detailed above. In specific embodiments, the composition is free of a catalyst. Advantageously, it is not necessary to subject the cured substrate to any pre-treatment or cleaning step prior to applying the primer, i.e., methods, such as corona treatment, plasma treatment, flame treatment, UV irradiation are unnecessary. As noted above, the substrate may also be free of a catalyst, at least on the surface thereof.

The primer composition may be applied using any suitable known method, for example, depending on the viscosity of the primer composition the primer may be applied by spraying, rolling, brushing, application with a knife coater or the like or the substrate may in certain circumstances be coated by immersion in a bath of primer. Typically, immediately upon application, a uniform primer film covering the substrate is provided. However, if required, the primer may be allowed to air-dry for a period of time at room temperature on the substrate surface prior to application of silicone elastomer composition e.g., for 2 to 10 minutes. Optionally, the substrate coated with primer may be heated to accelerate the drying process if deemed necessary. For example, baking may be used to increase temperature and facilitate drying. It should be appreciated that drying is not the same as curing, as drying is merely the physical flashing of carrier or other solvents, volatiles, etc. while curing involves some form of chemical reaction, e.g., crosslinking. For drying, air can simply be passed over the applied primer composition, and such air can be of ambient temperature and/or pressure or drying may be facilitated by increased temperature and/or by reduced pressure.

The primer coating on the substrate can be of various thicknesses. Typically, the primer coating has an average thickness of from 0.01 to 3 mm, or optionally of from 0.01 to 2 mm. Thickness of the primer coating may be uniform or may vary. In general, thickness of the primer coating will reduce while drying as understood in the art.

After formation of a uniform primer film covering the substrate, a curable silicone elastomer composition is applied in a form required and is subsequently cured to obtain an overmolded composite with an adhesive bond between the original silicone rubber substrate and the cured composition applied thereto. It would appear that hydrosilylation curable elastomeric compositions may be overmolded on to a hydrosilylation cured substrate which has had the present primer pre-applied and the subsequently cured overmolded layer reliably remains adhered to the pre-cured substrate.

The silicone elastomeric substrate may have been prepared by curing a peroxide-crosslinking or hydrosilylation (addition)-crosslinking silicone elastomer composition or similarly by curing a fluorosilicone elastomer composition. Such compositions will generally also contain a filler and/or suitable cure package as described herein. The substrate may be cured from a composition comprising any suitable organosiloxane homopolymer, copolymer or mixtures of these polymers wherein the repeating units are one or more of, for example, dimethylsiloxane, methylvinylsiloxane, methylphenylsiloxane, phenylvinylsiloxane, 3,3,3-trifluoropropylmethylsiloxane, 3,3,3-trifluoropropylvinylsiloxane, and/or 3,3,3-trifluoropropylphenylsiloxane.

The substrate composition as described herein may be cured with a hydrosilylation cure package as described below or with a peroxide catalyst or mixtures of different types of peroxide catalysts.

The peroxide catalyst may be any of the well-known commercial peroxides used to cure silicone and/or fluorosilicone elastomer compositions. The amount of organic peroxide used is determined by the nature of the curing process, the organic peroxide used, and the composition used. Typically, the amount of peroxide catalyst utilized in a composition as described herein is from 0.2 to 3 wt. %, or optionally 0.2 to 2 wt. %, in each case based on the weight of the composition.

Suitable organic peroxides include, for example, substituted or unsubstituted dialkyl-, alkylaroyl-, diaroyl-peroxides, e.g., benzoyl peroxide and 2,4-dichlorobenzoyl peroxide, ditertiarybutyl peroxide, dicumyl peroxide, t-butyl cumyl peroxide, bis(t-butylperoxyisopropyl) benzene, bis(t-butylperoxy)-2,5-dimethyl hexyne, 2,4-dimethyl-2,5-di(t-butylperoxy) hexane, di-t-butyl peroxide, and 2,5-bis(tert-butyl peroxy)-2,5-dimethylhexane. When the substrate composition is peroxide cured, said composition may additionally comprise an organohydrogenpolysiloxane having at least 2, or optionally at least 3, Si—H groups per molecule as described below.

The hydrosilylation curable silicone elastomer composition used for application onto the primer treated silicone elastomer substrate may comprise:
(i) one or more polydiorganosiloxane polymers such as component (C) in the primer composition described above;
(ii) a reinforcing filler, typically a silica reinforcing filler such as component (B) in the primer composition together with a hydrosilylation cure package.

The hydrosilylation cure package contains an organohydrogenpolysiloxane having at least 2, or optionally at least 3, Si—H groups per molecule (iii), a hydrosilylation catalyst (iv), and optionally a cure inhibitor (v).

The hydrosilylation curable silicone elastomer composition used for application onto the primer treated silicone elastomer substrate is cured using a hydrosilylation catalyst package in the form of
(iii) an organohydrogenpolysiloxane having at least 2, or optionally at least 3, Si—H groups per molecule;
(iv) a hydrosilylation catalyst; and optionally
   (v) a cure inhibitor.
(iii) Organohydrogenpolysiloxane

Organohydrogenpolysiloxane (iii) of the hydrosilylation curable silicone elastomer composition used for application onto the primer treated silicone elastomer substrate functions as a cross-linker for curing polymer (i) by addition/hydrosilylation reaction of the silicon-bonded hydrogen atoms in component (iii) with the alkenyl groups in polymer (i) catalyzed by component (iv) described below.

Organohydrogenpolysiloxane (iii) normally contains 3 or more silicon-bonded hydrogen atoms so that the hydrogen atoms can react with the unsaturated alkenyl or alkynyl groups of polymer (i) to form a network structure therewith and thereby cure the composition. Some or all of organohydrogenpolysiloxane (iii) may optionally have 2 silicon bonded hydrogen atoms per molecule when polymer (i) has >2 alkenyl or alkynyl groups per molecule.

The molecular configuration of organohydrogenpolysiloxane (iii) is not specifically restricted, and it can be a straight chain, a straight chain with some branching, cyclic or silicone resin based. While the molecular weight of this component is not specifically restricted, the viscosity is typically from 0.001 to 50 Pa-s at 25° C. relying on the cup/spindle method of ASTM D 1084 Method B, using the most appropriate spindle from the Brookfield® RV or LV range for the viscosity range, in order to obtain a good miscibility with polymer (i).

Organohydrogenpolysiloxane (iii) of the hydrosilylation curable silicone elastomer composition used for application onto the primer treated silicone elastomer substrate is typically added in an amount such that the molar ratio of the total number of the silicon-bonded hydrogen atoms in organohydrogenpolysiloxane (iii) to the total number of alkenyl and/or alkynyl groups in polymer (i) is from 0.5:1 to 20:1. When this ratio is less than 0.5:1, a well-cured composition will not be obtained. When the ratio exceeds 20:1, there is a tendency for the hardness of the cured composition to increase when heated.

Examples of organohydrogenpolysiloxane (iii) include, but are not limited to: trimethylsiloxy-terminated methylhydrogenpolysiloxane, trimethylsiloxy-terminated polydimethylsiloxane-methylhydrogensiloxane, dimethylhydrogensiloxy-terminated dimethylsiloxane-methylhydrogensiloxane copolymers, dimethylsiloxane-methylhydrogensiloxane cyclic copolymers, copolymers and/or silicon resins consisting of (CH₃)₂HSiO_{1/2} units, (CH₃)₃SiO_{1/2} units and SiO_{4/2} units, copolymers and/or silicone resins consisting of (CH₃)₂HSiO_{1/2} units and SiO_{4/2} units, copolymers and/or silicone resins consisting of (CH₃)₂HSiO_{1/2} units, SiO_{4/2} units and (C₆H₅)₃SiO_{1/2} units, and alternatives in which methyl is replaced by phenyl groups or other alkyl groups.

Optionally, component (iii) may be a filler, e.g., silica treated with one of the above.

The silicon-bonded hydrogen (Si—H) content of organohydrogenpolysiloxane (iii) of the hydrosilylation curable silicone elastomer composition used for application onto the primer treated silicone elastomer substrate is determined using quantitative infra-red analysis in accordance with ASTM E168. In the present instance the silicon-bonded hydrogen to alkenyl (vinyl) and/or alkynyl ratio is important when relying on a hydrosilylation cure process. Generally, this is determined by calculating the total weight % of alkenyl groups in the composition, e.g., vinyl [V] and the total weight % of silicon bonded hydrogen [H] in the composition and given the molecular weight of hydrogen is 1 and of vinyl is 27 the molar ratio of silicon bonded hydrogen to vinyl is 27[H]/[V].

### (iv) Hydrosilylation Catalyst

When present, hydrosilylation catalyst (iv) of the hydrosilylation curable silicone elastomer composition used for application onto the primer treated silicone elastomer substrate is preferably one of the platinum metals (platinum, ruthenium, osmium, rhodium, iridium and palladium), or a compound of one or more of such metals. Platinum and platinum compounds are preferred due to the high activity level of these catalysts in hydrosilylation reactions.

Examples of preferred hydrosilylation catalysts (iv) include, but are not limited to, platinum black, platinum on various solid supports, chloroplatinic acids, alcohol solutions of chloroplatinic acid, and complexes of chloroplatinic acid with ethylenically unsaturated compounds such as olefins and organosiloxanes containing ethylenically unsaturated silicon-bonded hydrocarbon groups. The catalyst (iv) can be platinum metal, platinum metal deposited on a carrier, such as silica gel or powdered charcoal, or a compound or complex of a platinum group metal.

Examples of suitable platinum-based catalysts include:
complexes of chloroplatinic acid with organosiloxanes containing ethylenically unsaturated hydrocarbon groups are described in U.S. Pat. No. 3,419,593;
chloroplatinic acid, either in hexahydrate form or anhydrous form;
a platinum-containing catalyst which is obtained by a method comprising reacting chloroplatinic acid with an aliphatically unsaturated organosilicon compound, such as divinyltetramethyldisiloxane; alkene-platinum-silyl complexes as described in U.S. Pat. No. 6,605,734 such as (COD)Pt(SiMeCl₂)₂ where “COD” is 1,5-cyclooctadiene; and/or Karstedt's catalyst, a platinum divinyl tetramethyl disiloxane complex typically containing about 1 wt. % of platinum in a solvent, such as toluene may be used. These are described in U.S. Pat. Nos. 3,715,334 and 3,814,730.

The hydrosilylation catalyst (iv) of the hydrosilylation curable silicone elastomer composition used for application onto the primer treated silicone elastomer substrate is present in the total composition in a catalytic amount, i.e., an amount or quantity sufficient to catalyze the addition/hydrosilylation reaction and cure the composition to an elastomeric material under the desired conditions. Varying levels of the hydrosilylation catalyst (iv) can be used to tailor reaction rate and cure kinetics. The catalytic amount of the hydrosilylation catalyst (iv) is generally between 0.01 ppm, and 10,000 parts by weight of platinum-group metal, per million parts (ppm), based on the weight of the composition polymer (i) and filler (ii); optionally, between 0.01 and 5,000 ppm; optionally, between 0.01 and 3,000 ppm, and optionally between 0.01 and 1,000 ppm. In specific embodiments, the catalytic amount of the catalyst may range from 0.01 to 1,000 ppm, optionally 0.01 to 750 ppm, optionally 0.01 to 500 ppm and optionally 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst package is provided the amount of catalyst present will be within the range of from 0.001 to 3.0 wt. % of the composition.

### (v) Cure Inhibitor

When the hydrosilylation curable silicone elastomer composition used for application onto the primer treated silicone elastomer substrate as hereinbefore described is being cured via an addition/hydrosilylation reaction component (v) an inhibitor may be utilized to inhibit the cure of the composition. These inhibitors (v) are utilized to prevent premature cure in storage and/or to obtain a longer working time or pot life of a hydrosilylation cured composition by retarding or suppressing the activity of the catalyst. Inhibitors (v) of hydrosilylation catalysts (iv), e.g., platinum metal-based catalysts are well known in the art and may include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines.

One class of known inhibitors (v) of hydrosilylation catalysts, e.g., platinum catalysts (iv) includes the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargyl alcohol, 3,5-dimethyl-1-hexyn-3-ol, 1-ethynylcyclopentanol, 1-phenyl-2-propynol, 3-methyl-1-penten-4-yn-3-ol, and mixtures thereof.

When present, inhibitor (v) concentrations as low as 1 mole of inhibitor per mole of the metal of catalyst (iv) will in some instances impart satisfactory storage stability and cure rate. In other instances, inhibitor concentrations of up to 500 moles of inhibitor per mole of the metal of catalyst (iv) are required. The optimum concentration for a given inhibitor (v) in a given hydrosilylation curable silicone elastomer composition used for application onto the primer treated silicone elastomer substrate is readily determined by routine experimentation. Dependent on the concentration and form in which the inhibitor selected is provided/available commercially, when present in the composition, the inhibitor is typically present in an amount of from 0.0125 to 10 wt. % of the composition. Mixtures of the above may also be used.

Typically the hydrosilylation curable silicone elastomer composition used for application onto the primer treated silicone elastomer substrate is stored in two parts, often referred to as Part A and Part B with a view to separating organohydrogenpolysiloxane (iii) and catalyst (iv) prior to cure to avoid premature cure as will be discussed further below. Such two-part compositions are composed to enable easy mixing immediately prior to use and are typically in a weight ratio of Part A:Part B of from 15:1 to 1:1.

### Additional/Optional Components

Additional optional components may be present in the silicone elastomer composition depending on the intended use thereof. Examples of such optional components include electrical and thermally conductive fillers, non-conductive fillers, pot life extenders, flame retardants, lubricants, non-reinforcing fillers, pigments coloring agents, chain extenders, mold release agents, UV light stabilizers, bactericides, wetting agents, heat stabilizers, compression set improvement additives, and mixtures thereof.

The silicone rubber composition may be dependent on viscosity and application etc., be applied onto the primer-treated substrate by way of by injection molding, encapsulation molding, press molding, dispenser molding, extrusion molding, transfer molding, press vulcanization, centrifugal casting, calendaring, bead application, 3-D printing or blow molding.

Curing of the silicone rubber composition may be carried out as required by the type of cure package utilized. While it is usually preferred to use raised temperatures for curing hydrosilylation cure systems e.g., from about 80° C. to about 150° C., some applications for which the primer herein is suitable e.g., for subsea silicone rubber compositions, much lower temperatures may be utilized for the cure process, e.g., between room temperature and 80° C., or optionally between room temperature, i.e., about 23-25° C. to about 50° C.

The present primer is particularly suited for applications where silicone elastomer/silicone elastomer overmolding is desired, e.g., subsea insulation, high-voltage electrical insulation, 3-D printing, lenses, automotive applications and consumer applications, i.e., situations where strong bonds need to be developed between pre-formed silicone elastomeric materials and uncured hydrosilylation curable silicone elastomeric compositions as they cure. While the overmolding may involve like silicone elastomers, i.e., those having the same or a very similar uncured composition, one particularly important application for the primers herein is to aid adhesion of silicone elastomeric materials having different properties for example different Shore A hardnesses, different colors, different optical transparencies, or any other difference in physical characteristics which may be advantageous for combination.

Hence, the primers as hereinbefore described may be suitable in the adherence of composite parts of articles such as in automotive applications housings with a silicone seal or gasket, plugs and connectors, components of various sensors, membranes, diaphragms, climate venting components, and the like. Composite parts may also include devices such as masks, goggles, tubing and valves catheters, ostomy appliances, respiratory appliances, feeding appliances, contact lenses, hearing aids, orthotics, prosthesis, and the like. Other composite parts which might need two layers of silicone having different physical properties (when cured) can include shower heads, bakery ware, spatulas, home appliances, shoes, footwear, sports and leisure articles, diving masks, face masks, pacifiers and other baby articles, feeding accessories, seals and surfaces of white good and other kitchen articles, and the like. Electronic applications may include silicone elastomer composites in mobile phone cover seal, mobile phone accessories, precision electronic equipment, electrical switches and switch covers, watches and wristbands, wearable electronic devices, and the like.

In the case of subsea insulation, silicone elastomeric materials are especially suited because the application requires any insulation material which is used must be able to withstand these extreme temperatures without detriment to its thermal or mechanical properties because of the extreme temperatures of the hydrocarbon fluids exiting wells, which in some cases may reach 150° C. or higher. The insulation needs to be resistant to the corrosive nature of seawater e.g., in the area immediately below the surface of the sea, up to a depth of about 50 m because it can be subjected to the effects of weather and turbulence under the surface due to prevailing weather conditions. In some instances, therefore the silicone elastomer composition used may comprise a syntactic medium such as microspheres, optionally glass microspheres, particularly borosilicate glass microspheres.

Typically in subsea applications the silicone elastomeric composition to be adhered to the substrate will have the same or a very similar composition to that of the substrate prior to curing because it is used in sequential molding (cast-in-place) of insulating materials. Because of the relatively low viscosity of the hydrosilylation curable silicone elastomer compositions utilized in subsea insulation material, it is applied onto items of subsea equipment for insulation purposes using a sequential molding (cast-in-place) process. In such a process a mold/form is placed in position for a first section of insulation around the item, liquid silicone rubber is subsequently pumped in and cured to a predetermined hardness and the mold/form is then removed. The process is then repeated for a second section and consequently for as many sections as required to complete the total insulation of the item of subsea equipment. However, such a sequential process results in multiple joint sections having neighboring silicone elastomer/silicone elastomer interfaces. And, while the silicone elastomer insulation provides excellent insulative properties, it has been identified that the adhesion/bonding between adjacent interfaces of neighboring sections is often inadequate for purpose, particularly given the extreme temperatures and environmental conditions endured. Use of the primers as hereinbefore described have been found to enhance the adhesion at the interface between a pre-cured silicone elastomeric material and a curing silicone elastomeric material which has been cast in place adjacent thereto.

The primers as hereinbefore described may be utilized in the thermal insulation of subsea equipment such as, for the sake of example, piping including riser pipes, wellheads, Xmas trees, spool pieces, manifolds, risers, pipework, e.g., a pipeline, jumpers, pipeline end terminations (PLETs), pipe line end manifolds (PLEMs), coupling covers, doghouses (i.e., rooms, which are typically steel-sided, adjacent to an oilrig floor, usually having an access door close to the driller's controls. They are generally at the same elevation as the rig floor but may be cantilevered out from the main substructure supporting the rig and/or pipe field joints using a cast in place process, whereby the primers described above are applied to surface of pre-cured silicone elastomeric material prior to a further section of silicone elastomer material (LSR) being introduced and cured with a view to ensuring the adhesion between multiple joint sections in the subsea insulation.

The following examples, illustrating the compositions and components of the compositions, elastomers, and methods, are intended to illustrate and not to limit the invention.

### EXAMPLES

In the following examples, the ingredients/components used are in the following examples and Tables are listed below:
DOWSIL™ 3-6060 Prime Coat Primer—a commercial primer for silicones from Dow Silicones Corp (Michigan, USA);
Silicone Polyether—is a Dimethyl(propyl(poly (EO))hydroxy)siloxy-terminated Dimethyl Siloxane, of the structure

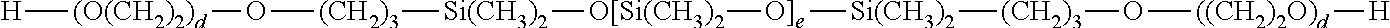

which has a viscosity of 320 mPa·s at 25° C.;
Treated Fumed Silica is a fumed silica which has been treated with hexamethyldisilazane (HMDZ);
Vinyl Polymer is a Dimethylvinyl terminated polydimethylsiloxane having a viscosity of 2,000 mPa·s at 25° C.; and
Si—H Polymer is a trimethyl terminated Dimethyl-methylhydrogen-siloxane having a viscosity of 5 mPa·s at 25° C. and 0.76 wt. % Si—H.

Except for C.1, the compositions indicated in Table 1 are all comparative primer compositions not in accordance with the disclosure herein. C.1 is a reference comparative example which uses no primer of any sort.

TABLE 1

| Components (wt. %) | C.1 | C.2 | C.3 | C.4 | C.5 | C.6 | C.7 | C.8 |
|---|---|---|---|---|---|---|---|---|
| DOWSIL ™ | | 100 | | | | | | |
| 3-6060 Prime | | | | | | | | |
| Coat Primer | | | | | | | | |
| Silicone Polyether | | | | | 0.14 | | 34 | 100 |
| Treated Fumed | | | 6.0 | | | 11.9 | | |
| silica | | | | | | | | |
| Vinyl Polymer | | | 27.4 | 33.2 | 32.8 | 22.1 | | |
| Octamethyltri- | | | 66 | 66 | 66 | 66 | 66 | |
| siloxane | | | | | | | | |
| Si—H Polymer | | | 0.65 | 0.8 | 1.03 | | | |

TABLE 2

| Components (wt. %) | Ex. 1 | Ex. 2 | Ex. 3 |
|---|---|---|---|
| Silicone polyether | 0.14 | 0.16 | 0.6 |
| Treated Fumed silica | 6.0 | 6.1 | 11.7 |
| Vinyl Polymer | 27.3 | 27.7 | 21.7 |
| Octamethyltrisiloxane | 66 | 66 | 66 |
| Si—H Polymer | 0.6 | | |

In order to test the comparative primers they were used in combination with a commercial subsea insulation material DOWSIL™ XTI-1003 RTV Silicone Rubber Insulation which is a room temperature vulcanizing two-part hydrosilylation cured composition designed particularly but not exclusively for subsea insulation applications. DOWSTL™ XTI-1003 RTV Silicone Rubber Insulation does not contain a catalyst.

100 parts of DOWSIL™ XTI-1003 Base were homogeneously mixed with 10 Parts of DOWSIL™ XTI-1003 Curing Agent and de-gassed in a vacuum desiccator. DOWSIL™ XTI-1003 Curing Agent does not contain a catalyst, other than a hydrosilylation catalyst. Using a cast-in place process, the resulting mixture was then cast into an open top mold (300×300 mm) to achieve a 5 mm thick layer. The material was left for 24 h at room temperature and in the laboratory to cure. After 24 h the experimental primer was applied by brushing onto the cured surface. Good primer coverage on the surface was visually controlled. The experimental primer used was dried for a period of 10 minutes after which the first cast coated with primer was overmolded with freshly mixed DOWSIL™ XTI-1003 RTV Silicone Rubber Insulation material of the same 5 mm thickness. The overmolded combination was then left for a further period of 24 h to enable the second cast of the DOWSIL™ XTI-1003 RTV Silicone Rubber Insulation material to cure at room temperature in the same laboratory conditions.

A 180° peel test method was used to determine the peel force between the two layer overmolded sample adhered together with the assistance of the primer utilized for the respective example. After the second cast material was fully cured 30 mm width strips were cut out for testing. Tests were performed on a Universalprufmaschine H10TMC 900 Watt machine from producer Hegewald & Peschke using following parameters:
Test speed 100 mm/min,
Load Cell 100 kN, and
Test length minimum 50 mm.

The results of the test for the comparative primers tested are depicted in Table 3 below and those for the examples in accordance with the present disclosure are depicted in Table 4 below.

TABLE 3

| Test results | C.1 | C.2 | C.3 | C.4 | C.5 | C.6 | C.7 | C.8 |
|---|---|---|---|---|---|---|---|---|
| Peel Force 180° [N] | 11 | 15.6 | 5.7 | 5.3 | 3.7 | 15.1 | 13.5 | 0 |

TABLE 4

| Test Results | Ex. 1 | Ex. 2 | Ex. 3 |
|---|---|---|---|
| Peel Force 180° [N] | 53.3 | 82.5 | 57.5 |

Several conclusions can be made by comparing the comparative examples and examples above. It can be seen that the peel force results of the examples are significantly better than when used in combination with any of the comparative primers of Table 1. More specifically, comparing comparative 3 with Example 1 the silicone polyether is required in the composition for adhesion promoted by the primer, without the polyether the adhesion results were poor (comp.3).

Similarly, it was found that by comparing comparative 5 with example 1 again that the silica is necessary for the primer to cause good adhesion. Furthermore, comparative 4 shows that the absence of both the polyether and silica results in poor adhesion, based on the peel tests. It had been anticipated that the adhesion would be enhanced by the introduction of the Si—H polymer but surprisingly when comparing examples 1 and 2 it was found that better results in the peel test performance were achieved in the absence of the Si—H polymer from the primer composition (although in its presence results were still much better than all the comparatives in Table 1).

Example 3 indicated that increasing the levels of silicone polyether and silica did not improve results in the examples. Finally, comparatives 7 and 8 show that a combination of carrier and polyether gave poor peel test results and as such didn't function well as a primer and use of the silicone polyether alone in comparative 8 didn't work at all.

### Additional Embodiments

The following additional embodiments are provided. Such embodiments can be used alone or in combination with one or more of the embodiments above. It is to be appreciated that various combinations of the embodiments herein are possible.

Embodiment 1 relates to a primer composition comprising:
A) a silicone polyether
B) a reinforcing filler
C) one or more polydiorganosiloxane polymer(s) having a viscosity of from 1,000 to 500,000 mPa·s at 25° C. containing at least one alkenyl group or alkynyl group per molecule and
D) a carrier.

Embodiment 2 relates to the primer composition of Embodiment 1, wherein component (A) comprises an ABA or AB type silicone polyether.

Embodiment 3 relates to the primer composition of any preceding Embodiment wherein component (A) is an ABA type silicone polyether of the formula

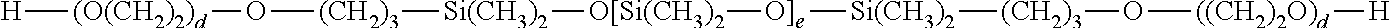

where d and e are integers.

Embodiment 4 relates to the primer composition of any preceding Embodiment wherein component (B) is a such as finely divided fumed silica and/or a finely divided precipitated silica and/or a silicone resin.

Embodiment 5 relates to the primer composition of any preceding Embodiment wherein component (C) is a dimethylvinyl terminated polydimethylsiloxane.

Embodiment 6 relates to the primer composition of any preceding Embodiment wherein component (D) is a short chain siloxane containing from 3 to 20 silicon atoms.

Embodiment 7 relates to the primer composition of any preceding Embodiment wherein the primer comprises
A) a silicone polyether in an amount of from 0.05 wt. % to 10 wt. % of the solids content of the composition;
B) a reinforcing filler in an amount of from 5.0 to 40 wt. % of the solids content of the composition;
C) one or more polydiorganosiloxane polymer(s) having a viscosity of from 1,000 to 500,000 mPa·s at 25° C. containing at least one alkenyl group or alkynyl group per molecule in an amount of from 40 to 90 wt. % of the solids content of the composition; wherein the solids content of the composition is the composition content excluding carrier (D), and carrier (D) in an amount of from 20 to 150 parts by weight, optionally from 70 to 150 parts by weight of a carrier (D) per 100 parts by weight of the solids content of the composition.

Embodiment 8 relates to the primer composition of any preceding Embodiment which comprises
A) a silicone polyether in an amount of from 0.05 wt. % to 4 wt. % of the total composition;
B) a reinforcing filler in an amount of from 2.0 to 20 wt. % of the total composition,
C) one or more polydiorganosiloxane polymer(s) having a viscosity of from 1,000 to 500,000 mPa·s at 25° C. containing at least one alkenyl group or alkynyl group per molecule in an amount of from 15 to 45 wt. % of the total composition; and
D) a carrier in a range of from 50 wt. % to 80 wt. % of the total composition.

Embodiment 9 relates to a process for the preparation of a primer composition in accordance with any preceding Embodiment, comprising uniformly dissolving or mixing components (A), (B), and (C) in carrier (D).

Embodiment 10 relates to a process in accordance with Embodiment 9 wherein the primer composition is diluted with further carrier after being mixed together.

Embodiment 11 relates to a method for improving the adhesion of silicone elastomer to a pre-cured silicone elastomeric substrate, comprising applying a primer composition in accordance with any one of Embodiments 1 to 8 to a silicone elastomer substrate, optionally air-drying or baking the primer composition to form a uniform primer film covering the substrate, applying of a hydrosilylation curable silicone rubber composition to the substrate covered with the primer to obtain a composite, and curing the composite in order to obtain a silicone elastomer adhesively bonded to a silicone elastomer substrate.

Embodiment 12 relates to a method for improving the adhesion of silicone elastomer to a pre-cured silicone elastomeric substrate in accordance with Embodiment 11 wherein the substrate is prepared from peroxide cured silicone elastomer composition and/or a hydrosilylation curable cured silicone elastomer composition.

Embodiment 13 relates to a method in accordance with Embodiment 11 or 12 wherein the hydrosilylation curable silicone rubber composition is applied onto the primer treated substrate by way of by injection molding, a cast in place process, encapsulation molding, press molding, dispenser molding, extrusion molding, transfer molding, press vulcanization, centrifugal casting, calendaring, bead application, 3-D printing or blow molding.

Embodiment 14 relates to a method in accordance with Embodiments 11, 12 or 13 wherein the hydrosilylation curable silicone rubber composition is applied onto the primer treated substrate using a cast in place process for the application of subsea insulation.

Embodiment 15 relates to a silicone elastomer composite of multiple silicone elastomer articles adhered or overmolded together using the primer in Embodiments 1 to 8.

Embodiment 16 relates to a silicone elastomer composite in accordance with Embodiment 15 wherein the composite is used in applications for subsea insulation, high-voltage electrical insulation, 3-D printing, lenses, automotive applications and/or consumer applications.

Embodiment 17 relates to a silicone rubber composite in accordance with Embodiment 15 or 16 wherein the composite is a subsea insulation composite.

Embodiment 18 relates to a silicone rubber composite in accordance with Embodiment 17 wherein the subsea insulation composite is used to insulate one or more of a piping wellhead, an Xmas tree, a spool piece, a manifold, a riser, a pipeline, a jumper, PLETs, PLEMs, a coupling cover, a doghouse and/or pipe field joints.

Embodiment 19 relates to a silicone rubber composite in accordance with Embodiment 15 or 16 suitable in or for adherence of housings with a silicone seal or gasket; plugs and connectors, components of various sensors, membranes, diaphragms, climate venting components, masks, goggles, tubing and valves catheters, ostomy appliances, respiratory appliances, feeding appliances, contact lenses, hearing aids, orthotics, prosthesis, shower heads, bakery ware, spatulas, home appliances, shoes, footwear, sports and leisure articles, diving masks, face masks, pacifiers, seals and surfaces of white goods, mobile phone cover seal, mobile phone accessories, precision electronic equipment, electrical switches and switch covers, watches and wristbands and/or wearable electronic devices.

Embodiment 20 relates to use of a primer composition in accordance with any one of Embodiments 1 to 8 in the manufacture of composites selected in or for subsea insulation, adherence of housings with a silicone seal or gasket; plugs and connectors, components of various sensors, membranes, diaphragms, climate venting components, masks, goggles, tubing and valves catheters, ostomy appliances, respiratory appliances, feeding appliances, contact lenses, hearing aids, orthotics, prosthesis, shower heads, bakery ware, spatulas, home appliances, shoes, footwear, sports and leisure articles, diving masks, face masks, pacifiers, seals and surfaces of white goods, mobile phone cover seal, mobile phone accessories, precision electronic equipment, electrical switches and switch covers, watches and wristbands and/or wearable electronic devices.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

What is claimed is:

1. A method for improving the adhesion of silicone elastomer to a pre-cured silicone elastomeric substrate, the method comprising:
applying a primer composition to a silicone elastomer substrate;
optionally, air-drying or baking the primer composition to form a uniform primer film covering the substrate;
applying a hydrosilylation curable silicone rubber composition to the substrate covered with the primer to obtain a composite; and
curing the composite in order to obtain a silicone elastomer adhesively bonded to a silicone elastomer substrate;
wherein the primer composition comprises:
(A) a silicone polyether;
(B) a reinforcing filler;
(C) one or more polydiorganosiloxane polymer(s) having a viscosity of from 1,000 to 500,000 mPa·s at 25° C. and containing at least one alkenyl group or alkynyl group per molecule; and
(D) a carrier.

2. The method in accordance with claim 1, wherein the substrate is prepared from a peroxide cured silicone elastomer composition and/or a hydrosilylation curable cured silicone elastomer composition.

3. The method in accordance with claim 1, wherein the hydrosilylation curable silicone rubber composition is applied onto the primer treated substrate by way of by injection molding, a cast in place process, encapsulation molding, press molding, dispenser molding, extrusion molding, transfer molding, press vulcanization, centrifugal casting, calendaring, bead application, 3-D printing, or blow molding.

4. The method in accordance with claim 1, wherein the hydrosilylation curable silicone rubber composition is applied onto the primer treated substrate via a cast in place process for the application of subsea insulation.

5. The method in accordance with claim 1, wherein component (A) comprises an ABA-type silicone polyether or an AB-type silicone polyether.

6. The method in accordance with claim 1, wherein component (A) is an ABA-type silicone polyether of the general formula: 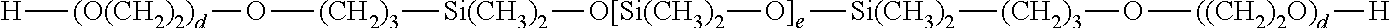
where each of d and e are integers.

7. The method in accordance with claim 1, wherein component (B) comprises a filler selected from the group consisting of finely divided fumed silica, finely divided precipitated silica, a silicone resin, and combinations thereof.

8. The method in accordance with claim 1, wherein component (C) is a dimethylvinyl-terminated polydimethylsiloxane.

9. The method in accordance with claim 1, wherein component (D) is a short chain siloxane containing from 3 to 20 silicon atoms.

10. The method in accordance with claim 1, wherein the primer composition comprises:
(A) the silicone polyether in an amount of from 0.05 to 10 wt. % of the solids content of the composition;
(B) the reinforcing filler in an amount of from 5.0 to 40 wt. % of the solids content of the composition;
(C) the polydiorganosiloxane polymer(s) in an amount of from 40 to 90 wt. % of the solids content of the composition;
wherein the solids content of the composition is the composition content excluding component (D); and
(D) the carrier in an amount of from 20 to 150 parts by weight, optionally of from 70 to 150 parts by weight, per 100 parts by weight of the solids content of the composition.

11. The method in accordance with claim 1, wherein the primer composition comprises:
(A) the silicone polyether in an amount of from 0.05 to 4 wt. % of the total composition;
(B) the reinforcing filler in an amount of from 2.0 to 20 wt. % of the total composition;
(C) the polydiorganosiloxane polymer(s) in an amount of from 15 to 45 wt. % of the total composition; and
(D) the carrier in an amount of from 50 to 80 wt. % of the total composition.

12. The method in accordance with claim 1, wherein the primer composition is prepared by uniformly dissolving or mixing components (A), (B), and (C) in component (D).

13. The method in accordance with claim 12, wherein the primer composition is diluted with further carrier after being dissolved or mixed together.

14. A silicone elastomer composite of multiple silicone elastomer articles adhered or overmolded together via the method in accordance with claim 1.

15. The silicone elastomer composite in accordance with claim 14, wherein the composite is used in applications for subsea insulation, high-voltage electrical insulation, 3-D printing, lenses, automotive applications, and/or consumer applications.

16. The silicone elastomer composite in accordance with claim 14, wherein the composite is a subsea insulation composite.

17. The silicone elastomer composite in accordance with claim 16, wherein the subsea insulation composite is used to insulate one or more of a piping wellhead, an Xmas tree, a spool piece, a manifold, a riser, a pipeline, a jumper, PLETs, PLEMs, a coupling cover, a doghouse, and/or pipe field joints.

18. The silicone elastomer composite in accordance with claim 14, suitable in or for adherence of housings with a silicone seal or gasket; plugs and connectors, components of sensors, membranes, diaphragms, climate venting components, masks, goggles, tubing and valves catheters, ostomy appliances, respiratory appliances, feeding appliances, contact lenses, hearing aids, orthotics, prosthesis, shower heads, bakery ware, spatulas, home appliances, shoes, footwear, sports and leisure articles, diving masks, face masks, pacifiers, seals and surfaces of white goods, mobile phone cover seals, mobile phone accessories, precision electronic equipment, electrical switches and switch covers, watches and wristbands and/or wearable electronic devices.

19. A primer composition comprising:
(A) a silicone polyether;
(B) a reinforcing filler;
(C) one or more polydiorganosiloxane polymer(s) having a viscosity of from 1,000 to 500,000 mPa·s at 25° C. and containing at least one alkenyl group or alkynyl group per molecule; and
(D) a carrier.

20. The primer composition in accordance with claim 19, wherein the composition is free of a catalyst.
